(19) United States
(12) Patent Application Publication
(10) Pub. No.: US 2026/0195115 A1
(43) Pub. Date: Jul. 9, 2026

(54) SERVICE PROVIDING APPARATUS, REPLICA NUMBER DETERMINATION METHOD, AND PROGRAM

(71) Applicant: NTT, Inc., Tokyo (JP)

(72) Inventors: Shiku HIRAI, Tokyo (JP); Hiroki BABA, Tokyo (JP)

(21) Appl. No.: 19/131,138

(22) PCT Filed: Dec. 5, 2022
(86) PCT No.: PCT/JP2022/044732

§ 371 Date: May 19, 2025

(51) Int. Cl. G06F 8/65

(52) U.S. Cl. CPC G06F 8/65

(57) ABSTRACT

The service providing device includes: an application unit that includes a plurality of interfaces and is activated on the basis of a specific event; a metric collection unit that collects metrics of respective interfaces in the plurality of interfaces; and a replica number determination unit that determines the number of replicas of the application unit on the basis of the metrics collected by the metric collection unit.

### TECHNICAL FIELD

The present invention relates to autoscaling for containerized applications.

### BACKGROUND ART

Development and provision of a service that uses a container orchestration base and uses Kubernetes (registered trademark) (Non Patent Literature 1) as a de facto standard are in progress. For example, usage of a container orchestration base for providing an NW function (NF) in a 5G core network (5GC) has been studied.

On the container orchestration base, for example, open source software Knative (Non Patent Literature 2) is installed, so that it is possible to construct a serverless base in an on-premises environment without depending on a managed service of a cloud provider.

### CITATION LIST

### Non Patent Literature

Non Patent Literature 1: Kubernetes Overview, https://kubernetes.io/docs/concepts/overview/
Non Patent Literature 2: Knative, https://knative.dev/docs/
Non Patent Literature 3: Knative Serving Overview, https://knative.dev/docs/serving/

### SUMMARY OF INVENTION

### Technical Problem

By a component referred to as Serving in Knative, the number of applications can be automatically increased or decreased (including generation and deletion) in accordance with the number of requests for a containerized application (Pod). This function is referred to as autoscaling.

However, prior art has a problem that autoscaling against a usage state may possibly be executed for a target application.

The present invention has been made in view of the above points, and an object thereof is to provide a technique capable of executing autoscaling for an application according to the usage state of the application.

### Solution to Problem

According to the disclosed technique, there is provided a service providing device including: an application unit that includes a plurality of interfaces and is activated on the basis of a specific event; a metric collection unit that collects metrics of respective interfaces in the plurality of interfaces; and a replica number determination unit that determines the number of replicas of the application unit on the basis of the metrics collected by the metric collection unit.

### Advantageous Effects of Invention

According to the disclosed technique, it is possible to execute autoscaling for an application according to the usage state of the application.

### BRIEF DESCRIPTION OF DRAWINGS

FIG. 1 is a diagram for explaining a problem.

FIG. 2 is a configuration diagram of a service providing device 100.

FIG. 3 is a flowchart for explaining an operation of the service providing device 100.

FIG. 4 is a diagram illustrating step numbers in a configuration diagram of the service providing device 100.

FIG. 5 is a diagram illustrating a hardware configuration example of a device.

### DESCRIPTION OF EMBODIMENTS

Hereinafter, an embodiment of the present invention (present embodiment) will be described with reference to the drawings. The embodiment to be described below is merely exemplary, and embodiments to which the present invention is applied are not limited to the following embodiment.

Although it is assumed that an environment that uses Knative on Kubernetes (registered trademark) is used in the following description, the technique according to the present invention is not limited to an environment that uses specific software such as Kubernetes (registered trademark) or Knative and can be implemented in various environments.

### Operation and Problem of Prior Art

First, a problem to be solved by the technique according to the present embodiment will be described by describing a device operation based on prior art. Note that description of the following problem is not publicly known.

As described above, on the container orchestration base that uses Kubernetes (Non Patent Literature 1) as the de facto standard, it is possible to construct a serverless base in an on-premises environment without depending on a managed service of a cloud provider by installing open source software Knative (Non Patent Literature 2).

Knative is software that enables application execution in a serverless manner, and there are Knative Serving and Knative Eventing as main components. Knative Serving (Non Patent Literature 3) is a component that provides a function of publishing, executing, and managing an application. Knative Eventing is a component that performs event-driven application execution.

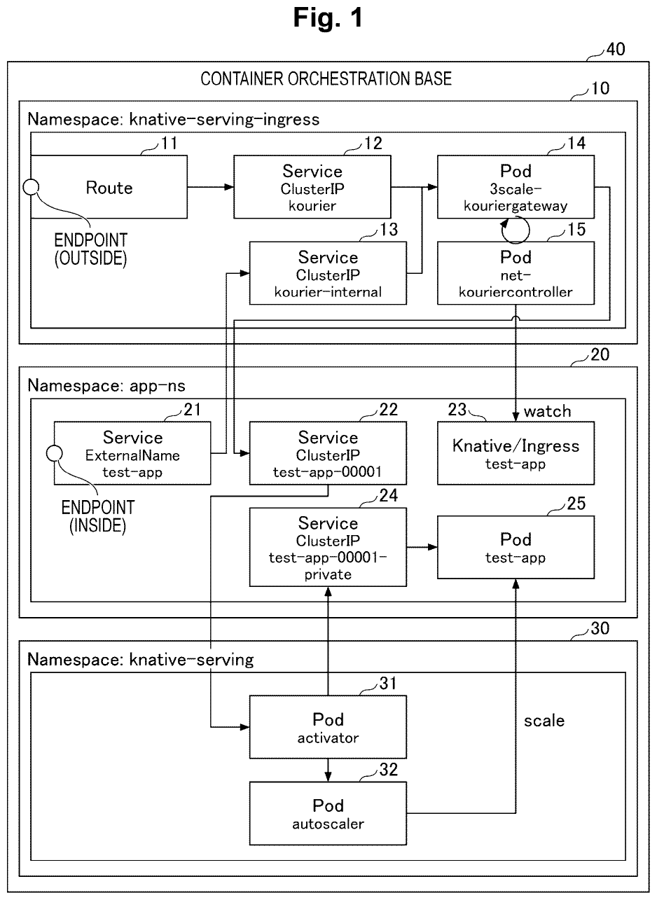

An example of operation in a container orchestration base 40 of prior art will be described with reference to FIG. 1. In the configuration illustrated in FIG. 1, Namespace is a virtual cluster. An endpoint is a portion (function) connected with a network.

In FIG. 1, publishing of an endpoint for the outside and routing of traffic between Revisions are performed on an object in Namespace 10 (knative-serving-ingress). An endpoint for the inside is published in Namespace 20 (app-ns). Pod 25, which is a containerized application, is executed by the Namespace 20.

As illustrated in FIG. 1, the deployed Pod 25 is published through an endpoint for the outside and an endpoint for the inside of a cluster.

Traffic inputted from endpoints (for the outside, for the inside) reaches Pod 14 (3scale-kourier-gateway) of the Namespace 10 (knative-serving-ingress). The Pod 14 (3scale-kourier-gateway) is a component (actually, envoy) that performs traffic routing. Routing setting is managed by Pod 15 (net-kourier-controller) in the same Namespace 10.

Traffic that has reached the Pod 14 from the endpoint travels through Service 22 in the Namespace 20 and reaches Pod 31 (activator) in Namespace 30 (knative-serving). The Pod 31 (activator) has a role of activating the Pod 25. In a case where the number of Pod 25 is 0, the scaling processing is performed through the Pod 31 (activator) and Pod 32 (autoscaler) of the Namespace 30 (knative-serving).

### Problem

In a conventional configuration illustrated in FIG. 1, traffic is routed through an external endpoint or an internal endpoint to a single container network interface (CNI) provided in the Pod 25 which is a containerized application to be subjected to scaling processing.

At that time, a metric (index value) used for execution of the scaling processing is the number of HTTP requests generated through the endpoint, and the processing of the autoscaling (including generation and deletion) for the Pod is dynamically executed in accordance with the increase or decrease of the metric.

In the present embodiment, it is assumed that an object to be executed and managed by Serving is a containerized NW function (e.g., NF in 5GC).

Normally, since the NW function has a plurality of interfaces (C plane/U plane/M plane, etc.), an operation against an actual usage state of the NW function may possibly be performed on a conventional serverless base that monitors only metrics of a single CNI. The operation against the usage state of the NW function is, for example, the following operation.

For example, in a case where the NW function is a virtual router, Serving is executed in response to a setting input of the M plane, and the traffic transfer processing of the C/U planes occurs after the Pod is generated. However, in prior art, only the metrics of the M plane are monitored, and therefore deletion of Pod unintended by the user may possibly be executed on the serverless base side during the traffic transfer processing of the C/U planes.

### Outline of Embodiment

In order to solve the above-described problem, the service providing device 100 in the present embodiment includes a metric collection unit 160 and a replica number determination unit 130.

The metric collection unit 160 collects metrics (the number of C-plane call connections per unit time, U-plane data throughput, etc.) respectively related to the plurality of interfaces in real time for the containerized NW function (application unit 150). On the basis of the metrics collected by the metric collection unit 160, the replica number determination unit 130 determines an appropriate number of replicas according to the usage state of the target NW function (application unit 150).

With the above configuration, it is possible to apply the containerized NW function having a plurality of CNIs, which is difficult to apply on a conventional serverless base, and it is possible to realize appropriate life cycle management according to the usage state of the target NW function.

Hereinafter, the device configuration and the device operation in the present embodiment will be described in detail.

### (Device Configuration Example)

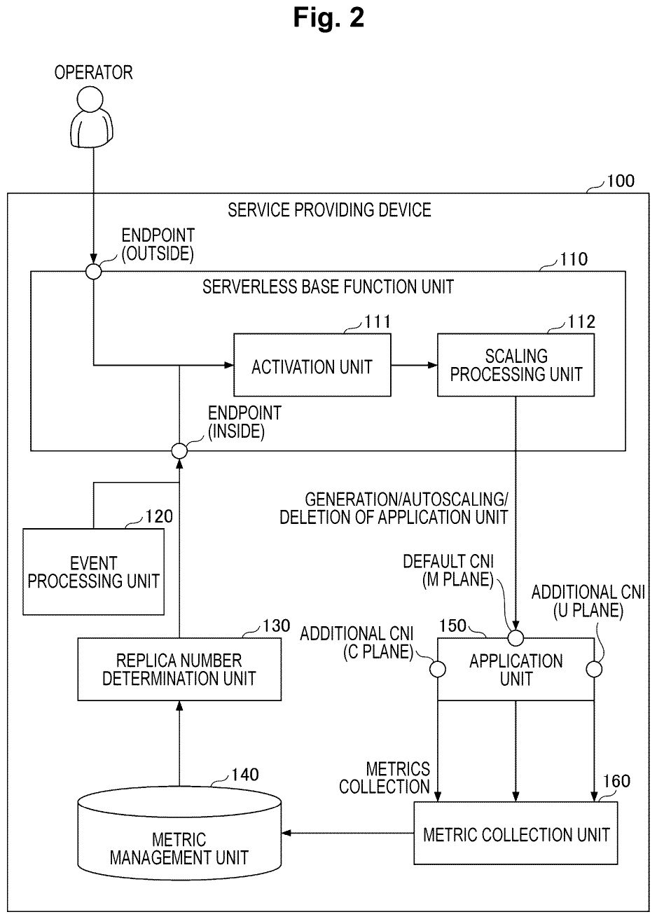

FIG. 2 illustrates a configuration example of the service providing device 100 in the present embodiment. As illustrated in FIG. 2, the service providing device 100 includes a serverless base function unit 110, an event processing unit 120, the replica number determination unit 130, a metric management unit 140, an application unit 150, and the metric collection unit 160.

The service providing device 100 is a computer on which software operates. The computer may be a physical machine, a virtual machine, or a container. In the present embodiment, it is assumed that the service providing device 100 is a computer on which software of a container orchestration base such as Kubernetes (registered trademark) operates.

The replica number determination unit 130 acquires the metrics collected from the target application unit 150 from the metric management unit 140, and determines an appropriate number of replicas of the application unit 150 on the basis of a rule defined in advance for the acquired metrics (the number of C-plane call connections per unit time, U-plane data throughput, etc.) for each CNI. Moreover, the replica number determination unit 130 notifies the serverless base function unit 110 of the determined number of replicas of the application unit 150 through the internal endpoint.

It is assumed that the serverless base function unit 110 is a conventional serverless base function such as Knative Serving or a managed service of a cloud provider, for example.

The serverless base function unit 110 has external and internal endpoints capable of routing traffic to a default CNI of the target containerized NW function (application unit 150). Moreover, the serverless base function unit 110 includes an activation unit 111 and a scaling processing unit 112. The activation unit 111 corresponds to the Pod 31 (activator) illustrated in FIG. 1, and the scaling processing unit 112 corresponds to the Pod 32 (autoscaler).

The event processing unit 120 is a component having a function of calling an application with some event as a trigger, that is, a function of executing an application by event drive. The event processing unit 120 is implemented by, for example, Knative Eventing.

The application unit 150 is a containerized NW function to be controlled. In the present embodiment assuming usage of Kubernetes (registered trademark), the application unit 150 may be referred to as Pod.

The application unit 150 includes a default CNI for M-plane communication, an additional CNI for C-plane communication, and an additional CNI for U-plane communication, in which setting input unique to the application can be performed through Rest API.

“CNI” is an example of an interface. The M plane is a management plane, the C plane is a control plane, and the U plane is a user plane.

Note that usage of three interfaces of a default CNI for M-plane communication, an additional CNI for C-plane communication, and an additional CNI for U-plane communication as interfaces of the application unit 150 is an example. As the interface of the application unit 150, two interfaces may be used, or four or more interfaces may be used.

Moreover, the application unit 150 may be an application other than the NW function. Moreover, the service providing device 100 may include a plurality of application units. In a case where a plurality of application units is provided, control described regarding the application unit 150 in the present embodiment is executed for each application unit.

The metric collection unit 160 collects metrics of the application unit 150 activated on the service providing device 100. The metric collection unit 160 is implemented by, for example, Prometheus (registered trademark).

The metric management unit 140 stores the metrics of the application unit 150 activated on the service providing device 100 collected by the metric collection unit 160.

### (Device Operation Example)

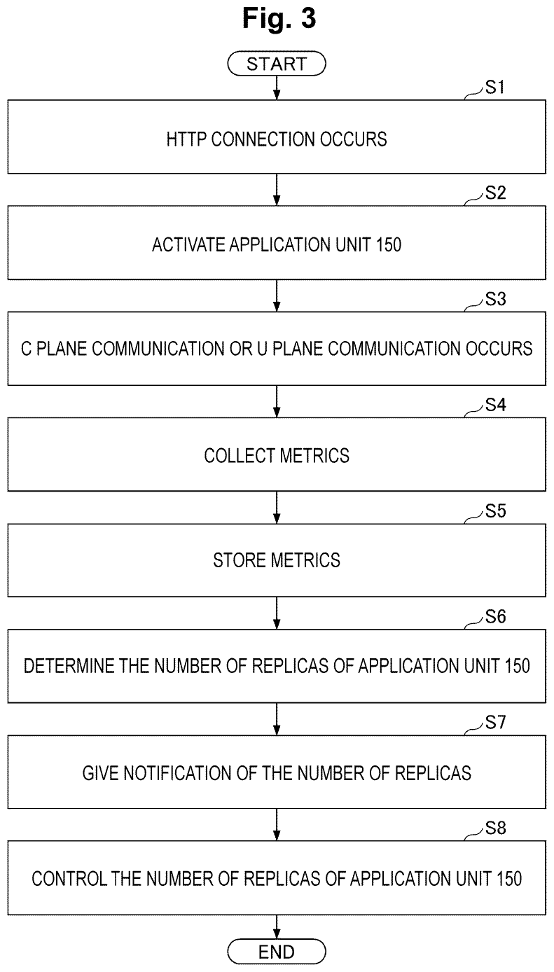

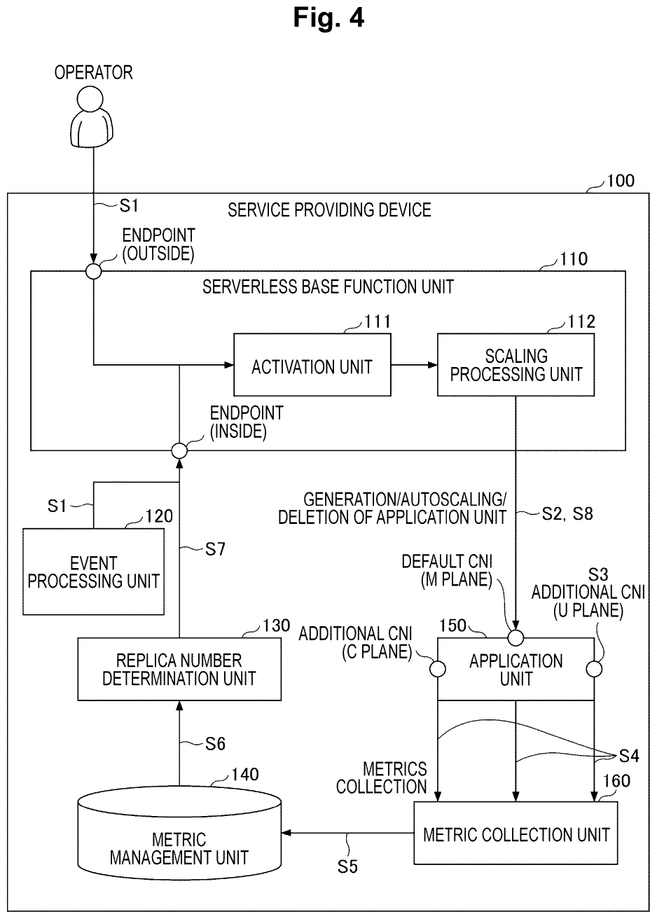

Next, an operation example of the service providing device 100 will be described with reference to a flowchart of FIG. 3. Moreover, each step number illustrated in FIG. 3 is shown in the configuration diagram of FIG. 4.

In S1, when setting input unique to the application unit 150 is performed by an operator who manages the application unit 150, HTTP connection occurs to the default CNI (M plane) of the application unit 150 through the external endpoint of the serverless base function unit 110.

Alternatively, in S1, notification of occurrence of a specific event is given by the event processing unit 120, and HTTP connection occurs through external and internal endpoints of the serverless base function unit 110.

In response to the occurrence of HTTP connection in S1, the scaling processing unit 112 (or the activation unit 111) activates the application unit 150 in S2 with the number of replicas of the application unit 150 set to 1. Note that the occurrence of HTTP connection is an example of a specific event. The application unit 150 may be activated with an event other than the occurrence of the HTTP connection as a trigger.

In S3, the C-plane communication or the U-plane communication using an additional CNI occurs for the activated application unit 150.

In S4, the metric collection unit 160 collects related metrics from a corresponding additional CNI for the occurring C-plane communication or U-plane communication. The metrics to be collected are, for example, the number of call connections per unit time obtained in the C plane, the data throughput of the U plane, or the like. For each CNI, one type of metrics may be collected, or a plurality of types of metrics may be collected.

In S5, the collected metrics of each CNI are transmitted to the metric management unit 140 and stored.

In S6, the replica number determination unit 130 acquires metrics of each CNI of the target application unit 150 from the metric management unit 140.

The replica number determination unit 130 determines the number of replicas of the application unit 150 on the basis of a rule defined in advance for the acquired metrics of each CNI. The number of replicas to be determined is a value of 0 or more. In this rule, for example, a predetermined threshold is used.

For example, since the data throughput of the U plane exceeds the threshold of 10 Gbps, the replica number determination unit 130 makes a determination to increase the number of replicas from 1 to 2.

Moreover, the replica number determination unit 130 may determine the number of replicas by using metrics of some CNIs (one CNI or a plurality of CNIs) among all the CNIs included in the application unit 150, or may determine the number of replicas by using metrics of all the CNIs.

For example, if “(metric A of CNI of U plane is equal to or larger than threshold 1) and (metric B of CNI of C plane is equal to or larger than threshold 2)” is satisfied, the replica number determination unit 130 may make a determination to increase the number of replicas by a predetermined value.

Moreover, if “(metric A of CNI of U plane is equal to or larger than threshold 1) or (metric B of CNI of C plane is equal to or larger than threshold 2)” is satisfied, the replica number determination unit 130 may make a determination to increase the number of replicas by a predetermined value.

In S7, the replica number determination unit 130 notifies the scaling processing unit 112 of the number of replicas determined in S6 through the internal endpoint of the serverless base function unit 110.

In S8, the scaling processing unit 112 increases or decreases the number of replicas of the target application unit 150 in accordance with the number of replicas in notification given in S7.

### Other Examples

Although an example of a case where the application unit has an interface of each of the M plane, the C plane, and the U plane has been described in the above example as an example of a case where the application unit 150 has a plurality of interfaces (specifically, CNI), the present invention is not limited to such an example.

For example, the application unit 150 may include a plurality of interfaces including an interface for traffic of a high-quality service and an interface for traffic of a service that does not require high quality.

Moreover, the application unit 150 may include a plurality of interfaces including an interface for confidential traffic that requires high security and an interface for traffic that does not require high security.

In any of the above cases, the processing of acquiring metrics from each interface and determining the number of replicas is similar to the case of dividing the interfaces by the M plane, the C plane, and the U plane.

### (Hardware Configuration Example)

Any of the service providing devices 100 described in the present embodiment can be realized by causing a computer to execute a program. This computer may be a physical computer, or may be a virtual machine.

That is, the service providing device 100 can be realized by executing a program corresponding to processing performed by the service providing device 100 using hardware resources such as a CPU and a memory built in a computer. The above-described program can be stored and distributed by being recorded on a computer-readable recording medium (portable memory, etc.). Moreover, the program can be provided through a network such as the Internet or an electronic mail.

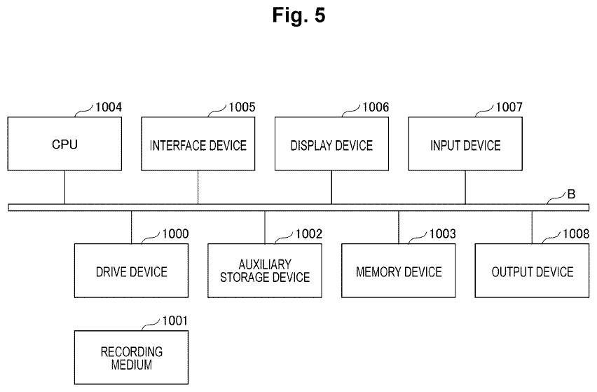

FIG. 5 is a diagram illustrating a hardware configuration example of the computer. The computer in FIG. 5 includes a drive device 1000, an auxiliary storage device 1002, a memory device 1003, a CPU 1004, an interface device 1005, a display device 1006, an input device 1007, an output device 1008, and the like, which are connected with each other by a bus B. Note that the computer may further include a GPU.

The program for implementing the processing in the computer is provided by a recording medium 1001 such as a CD-ROM or a memory card, for example. When the recording medium 1001 storing the program is set in the drive device 1000, the program is installed from the recording medium 1001 to the auxiliary storage device 1002 via the drive device 1000. However, the program is not necessarily installed from the recording medium 1001, and may be downloaded from another computer via a network. The auxiliary storage device 1002 stores the installed program, and also stores necessary files, data, and the like.

In a case where an instruction to activate the program is given, the memory device 1003 reads the program from the auxiliary storage device 1002 and stores the program. The CPU 1004 realizes a function related to the service providing device 100 according to a program stored in the memory device 1003. The interface device 1005 is used as an interface for connection with a network or the like. The display device 1006 displays a graphical user interface (GUI) or the like according to the program. The input device 1007 includes a keyboard and a mouse, a button, a touchscreen, or the like and is used to input various operation instructions. The output device 1008 outputs a calculation result.

### Effects of Embodiment

As described above, according to the technique described in the present embodiment, it is possible to execute autoscaling for an application according to the usage state of the application.

Regarding the above embodiment, the following supplementary notes are further disclosed.

### <Supplementary Notes>

### (Supplementary Note 1)

A service providing device including:
a memory; and
at least one processor connected with the memory,
wherein the processor is configured to:
activate an application unit including a plurality of interfaces on the basis of a specific event;
collect metrics of respective interfaces in the plurality of interfaces; and
determine the number of replicas of the application unit on the basis of the collected metrics.

### (Supplementary Note 2)

The service providing device according to supplementary note 1,
wherein the plurality of interfaces includes an interface for U-plane communication and an interface for C-plane communication.

### (Supplementary Note 3)

The service providing device according to supplementary note 1 or 2,
wherein the processor increases or decreases the number of application units in accordance with the determined number of replicas.

### (Supplementary Note 4)

A replica number determination method executed by a computer including an application unit that includes a plurality of interfaces and is activated on the basis of a specific event, the replica number determination method including:
a metric collection step of collecting metrics of respective interfaces in the plurality of interfaces; and
a replica number determination step of determining the number of replicas of the application unit on the basis of the metrics collected in the metric collection step.

### (Supplementary Note 5)

A non-transitory storage medium storing a program for causing a computer to function as each unit in the service providing device according to any one of supplementary notes 1 to 3.

Although the present embodiment has been described above, the present invention is not limited to such a specific embodiment, and various modifications and changes can be made within the scope of the gist of the present invention described in the claims.

### REFERENCE SIGNS LIST

100 Service providing device
110 Serverless base function unit
111 Activation unit
112 Scaling processing unit
120 Event processing unit
130 Replica number determination unit
140 Metric management unit
150 Application unit
160 Metric collection unit
1000 Drive device
1001 Recording medium
1002 Auxiliary storage device
1003 Memory device
1004 CPU
1005 Interface device
1006 Display device
1007 Input device
1008 Output device

1. A service providing apparatus comprising:
circuitry configured to operate a container orchestration base;
at least one application component including a plurality of interfaces and configured to be activated, based on a specific event, on the container orchestration base;
a metric collection component configured to collect, under the container orchestration base, metrics for each of the plurality of interfaces; and
a replica number determination component configured to determine, under the container orchestration base, a number of replicas of the application component based on the metrics collected by the metric collection component.

2. The service providing apparatus according to claim 1,
wherein the plurality of interfaces includes an interface for U-plane communication and an interface for C-plane communication.

3. The service providing apparatus according to claim 1, further comprising:
a scaling processing component configured to increase or decrease, under the container orchestration base, a number of application components in accordance with the number of replicas,
wherein the at least one application component includes the number of application components.

4. A replica number determination method executed by a computer including at least one application component that includes a plurality of interfaces and is activated, based on a specific event, on a container orchestration base, the replica number determination method comprising:
collecting metrics for each of the plurality of interfaces; and
determining a number of replicas of the application component based on the metrics.

5. A non-transitory computer readable storage medium storing a program for causing a computer to execute the replica number determination method of claim 4.
